(19) United States
(12) Patent Application Publication
(10) Pub. No.: US 2025/0165011 A1
(43) Pub. Date: May 22, 2025

(54) DRONE SYSTEM FOR SYNTHETIC APERTURE RADAR OPERATION AND OPERATING METHOD THEREOF

(71) Applicant: POSTECH RESEARCH AND BUSINESS DEVELOPMENT FOUNDATION, Pohang-si (KR)

(72) Inventors: Soohee HAN, Pohang-si (KR); Changhyeon LEE, Pohang-si (KR); Seongwon YOON, Pohang-si (KR); Seunghyeon SIM, Pohang-si (KR); Jooyeol JUNG, Pohang-si (KR); Woo Joung LIM, Pohang-si (KR)

(73) Assignee: POSTECH RESEARCH AND BUSINESS DEVELOPMENT FOUNDATION, Pohang-si (KR)

(21) Appl. No.: 18/926,170

(22) Filed: Oct. 24, 2024

(30) Foreign Application Priority Data
Nov. 21, 2023 (KR) 10-2023-0162551
Oct. 10, 2024 (KR) 10-2024-0137807

(51) Int. Cl. G05D 1/698; G05D 1/227; G05D 1/248; G05D 1/80; G05D 109/20; G05D 111/30

(52) U.S. Cl. CPC G05D 1/6985; G05D 1/227; G05D 1/248; G05D 1/80; G05D 2109/20; G05D 2111/32

(57) ABSTRACT

A drone system for synthetic aperture radar (SAR) operation to control and operate an aerial vehicle mounted with an SAR may comprise: a flight control module configured to control a low level of the aerial vehicle; a high-level control module configured to perform communication for swarm control of the aerial vehicles, receive flight information from the flight control module, and transmit a command to the flight control module; a link module configured to link the flight control module and the high-level control module; and a data acquisition board connected to the high-level control module and configured to store a flight log from the high-level control module and radar data from a radar module provided with the SAR.

### CROSS-REFERENCE TO RELATED APPLICATIONS

This application claims priority to Korean Patent Application No. 10-2023-0162551, filed on Nov. 21, 2023 and Korean Patent Application No. 10-2024-0137807, filed on Oct. 10, 2024, with the Korean Intellectual Property Office (KIPO), the entire contents of each of which are hereby incorporated by reference.

### BACKGROUND

### 1. Technical Field

The disclosure relates to a drone system for a synthetic aperture radar (SAR) operation, and more particularly to a drone system for an SAR operation using open-source hardware and an operating method thereof.

### 2. Related Art

A synthetic aperture radar (synthetic aperture radar, SAR) refers to a radar system that makes a topographic map or observes ground surfaces by processing delicate time differences between radar waves transmitted in sequence from the air to the ground or ocean and radar waves reflected and returned back from curved surfaces. The SAR transmits electromagnetic waves in the form of short and strong pulses or radio beams to a target area and measures time taken for the reflected waves to return to the radar antenna, thereby constructing a two-dimensional image.

To raise the resolution of the SAR, it is required to increase a distance resolution and an azimuth resolution by selectively receiving the reflected waves coming from only the target area while the electromagnetic waves short and sharp in time for minimizing the dispersion or refraction thereof are transmitted and the reflected waves are returned as short pulses. In particular, a parabolic antenna that has sharp directionality and looks like a concave mirror is used to increase the azimuth resolution. The larger the diameter of this antenna compared to the wavelength of a radio wave, the less the diffraction of the radio wave, thereby transceiving the beam sharply focused to one point.

In more detail, for example, a value obtained by dividing the diameter of the antenna by the wavelength of the radio wave is called an antenna aperture ratio (AR). The larger the antenna AR, the sharper the beam and the higher an antenna gain. However, if only the magnification is increased without increasing the diameter of the antenna, it is impossible to recognize the reflected wave because an image (diffraction image) is blurred due to the diffraction of light. Further, the antenna to be mounted to an aircraft is restricted in size and weight, and it is also difficult to rotate the large antenna quickly. In addition, there are practical problems such as technical limitations and severe attenuation in shortening the wavelength of the radio wave, and thus conventional radars for the aircraft have many limitations on their resolutions.

To solve the aforementioned problems, the SAR was developed to obtain a high azimuth resolution without increasing the diameter of the antenna. The radio beam used in the SAR has a relatively wide pulse width and also has a wide angular range because the antenna has a small diameter. The SAR is operated in such a manner that a radar device mounted to an airplane or satellite continuously receives radar reflected waves while moving quickly. This is because the reflective waves are received more sharply due to the same effect as if the diameter of the radar antenna is increased by a distance shifted while the radio waves are reflected and returned. In this way, the SAR is effective in acquiring a high-resolution ground image of a wide area from the air.

Meanwhile, when the antenna radiates the radio beam having a coherent phase while moving at high speed, there is a significant difference between the position of the antenna where the radio beam is radiated and the position of the antenna where the reflected wave is received, and the difference in position appears as a Doppler shift of the received radio wave. By using a relative shift characteristic of the Doppler shift, it is possible to obtain a synthesized antenna signal by a phase correction method for a distance difference between an object and a radar antenna, or obtain a synthesized antenna signal by adding signals having the same phase even though their reception points are different.

That is, using the movement of the radar, several consecutive radar signals received in the antenna having a small aperture may be synthesized to mathematically form the aperture of an antenna having a large aperture. For that reason, the SAR usually performs complicated signal processing so that several signals actually received therein while moving quickly can be processed to generate a clear image of a stationary radar.

In other words, unlike optical sensors for recording only the intensity of reflected visible light, the SAR uses signals, in which information about each pixel is a complex number, to generate a radar image. Here, the complex number has an absolute value and a polar angle. In the SAR image, the absolute value is directly related to the radar reflectivity of a corresponding terrain or object, and the polar angle refers to a phase of an electromagnetic wave and has some distance information between the radar and a target. Because the resolution of most SAR image is very long compared to the wavelength of the electromagnetic wave, phase information in one SAR image is hard to have significantly meaningful values.

Further, when two different SARs observe the same area from similar positions, an SAR-based image processing system can obtain three-dimensional information of a ground surface based on interference between two SAR images. In other words, because points having the same distance from the radar to an object form an arc on the zero-Doppler plane, a phase difference, i.e., an interference phase between two SAR images is proportional to distance differences between the target and the two radars, and points having the same interference phase are shaped extending radially with the midpoint between the two radars as the origin. In addition, because the trace of the same interference phase in places very close to the radar is formed as a hyperbola, i.e., a line connecting points where distance differences between two points are the same, it is often possible to approximate the trace as a straight line at a distance long enough to be captured in the SAR image. Therefore, when the positions of the two SARs are given in advance, a position on a target, where scattering occurred, is determined as an intersection point between a straight line corresponding to the observed interference phase and a circle corresponding to the distance from the radar, and determined as one. This intersection point is used to obtain the three-dimensional information because it is placed above or below the plane when the ground surface undulates.

Further, when two SARs observe a ground surface from a little distance from each other at the same time, the undulation of the ground surface is observed. Meanwhile, when the two SARs observes the same ground surface while moving along the same path, an observed interference phase is proportional to the movement of the ground surface or target between the two observations. To use the interference phase, the SAR-based observation devices operate at very short time intervals, thereby not only capturing fast movements of vehicles or sea waves but also obtaining the distance, direction and speed of the vehicles or sea waves, and quantitatively observing slow changes such as the uplift and subsidence of the ground surface over time intervals of several moments to years. The observation based on the interference phase has accuracy proportional to the wavelength of the used electromagnetic wave, and is thus used in monitoring earthquakes and volcanoes because it is capable of observing ground displacement of a few millimeters per year under good conditions. The ground moving target indication (GMTI) is also based on the sample principle.

Recently, research has been actively conducted to apply the SAR, which has been used as mounted to high-altitude unmanned aerial vehicle or satellites, to subminiature multi-rotors for reasons such as portability and ease of operation. The multi-rotor is also referred to as a multi-copter. A monostatic SAR drone system has a structure that transmitting and receiving modules of the radar are all mounted to one aerial vehicle to operate the SAR, and a bistatic SAR drone system has a structure that two aerial vehicles are used to operate the SAR and thus requires data synchronization for radar imaging and formation flight techniques between the two aerial vehicles. A multi-static SAR drone system refers to a system that uses two or more aerial vehicles to operate the SAR.

Compared to the operation of the monostatic SAR drone system in which the transmitting and receiving modules of the radar are all mounted to one aerial vehicle, it is difficult to operate the bistatic SAR drone system in terms of implementing the formation flight techniques between the two aerial vehicles, the data synchronization for the radar imaging, etc. In particular, the operation of the multi-static SAR drone system is more difficult to implement than the operation of the bistatic SAR drone system.

As a demand for a bistatic or multi-static SAR operation system increases, there is a growing demand for new drone system architecture or operation methods thereof to be easily and effectively applied to the drone systems for the bistatic or multi-static SAR operation.

### SUMMARY

The disclosure is conceived to meet the needs of the foregoing related art, and an aspect of the disclosure is to provide a drone system using open-source hardware, which can be easily implemented by even general users to operate a bistatic or multi-static synthetic aperture radar (SAR), and a method of operating the same.

Another aspect of the disclosure is to provide a drone system for SAR operation, in which user convenience, ease of operation, and stability, and a method of operating the same.

Still another aspect of the disclosure is to provide a drone system for SAR operation, which effectively performs a bistatic SAR scenario by individually attaching transceiving modules to two aerial vehicles, and a method of operating the same.

Yet another aspect of the disclosure is to provide a drone system for SAR operation, which effectively performs a multi-static SAR scenario by attaching transmitting modules, receiving modules or transceiving modules to three or more aerial vehicles, and a method of operating the same.

According to a first exemplary embodiment of the present disclosure, a drone system for synthetic aperture radar (SAR) operation to control and operate an aerial vehicle mounted with an SAR may comprise: a flight control module configured to control a low level of the aerial vehicle; a high-level control module configured to perform communication for swarm control of the aerial vehicles, receive flight information from the flight control module, and transmit a command to the flight control module; a link module configured to link the flight control module and the high-level control module; and a data acquisition board connected to the high-level control module and configured to store a flight log from the high-level control module and radar data from a radar module provided with the SAR.

The drone system may further comprise a satellite antenna connected to the flight control module and configured to receive a satellite signal from a satellite, and the flight control module may receive global positioning information calculated based on the satellite signal from the satellite antenna, and transmit the flight information based on the global positioning information to the high-level control module through the link module.

The drone system may further comprise a sensor connected to the flight control module and configured to transmit position information about a relative position of the aerial vehicle to the flight control module.

The drone system may further comprise a remote-control receiver connected to the high-level control module and configured to transmit a command received from an external controller to the high-level control module.

The aerial vehicle may be a follower aerial vehicle, and the high-level control module may receive a command for controlling operations of the follower aerial vehicle from the remote-control receiver based on operation mode switching upon preset emergency situations such as malfunction of a leader aerial vehicle or poor communication of the leader aerial vehicle.

The high-level control module may provide position target information of the aerial vehicle to the flight control module, and the flight control module may provide estimated position information about the aerial vehicle to the high-level control module.

The high-level control module may perform communication control between a leader aerial vehicle and a follower aerial vehicle or communication control between agents, and the leader aerial vehicle may provide estimated position information or leader reference position information to the follower aerial vehicle.

The data acquisition board may exchange global positioning system (GPS) time for synchronization or leader-follower communication with another aerial vehicle with a data acquisition board of the other aerial vehicle.

The data acquisition board may comprise a single board computer module.

The drone system may further comprise an electric speed controller connected to the flight control module.

According to a second exemplary embodiment of the present disclosure, a method of operating a synthetic aperture radar (SAR) operation drone system for controlling and operating an aerial vehicle mounted with an SAR may comprise: by a flight control module, controlling a low level of the aerial vehicle; by a high-level control module linked to the flight control module through a link module, performing communication for swarm control of the aerial vehicles, by the high-level control module, receiving flight information from the flight control module, and transmitting a command to the flight control module; and by a data acquisition board connected to the high-level control module, storing a flight log from the high-level control module and radar data from a radar module provided with the SAR.

The method may further comprise: by a satellite antenna connected to the flight control module, receiving a satellite signal from a satellite; and by the satellite antenna, transmitting global positioning information calculated based on the satellite signal to the flight control module, wherein the flight control module may transmit the flight information based on the global positioning information to the high-level control module through the link module.

The method may further comprise, by a sensor connected to the flight control module, transmitting position information about a relative position of the aerial vehicle to the flight control module.

The method may further comprise, by a remote-control receiver connected to the high-level control module, transmitting a command received from an external controller to the high-level control module, wherein the command may be received in the remote-control receiver from the external controller for remote control of the aerial vehicle, the SAR or the formation flight.

The method may further comprise, by the high-level control module, receiving a command based on a remote-control signal of the controller from the remote-control receiver, wherein the command may be transmitted to the aerial vehicle serving as a leader aerial vehicle, or transmitted to a follower aerial vehicle that has performed a swarm flight together with the leader aerial vehicle and switched over to a leader aerial vehicle mode based on operation mode switching upon preset emergency situations such as malfunction of the leader aerial vehicle or poor communication of the leader aerial vehicle.

The method may further comprise: by the high-level control module, providing position target information of the aerial vehicle to the flight control module; and by the flight control module, providing estimated position information about the aerial vehicle to the high-level control module.

The method may further comprise, by the high-level control module, allowing the aerial vehicle to perform leader-follower communication with a counterpart aerial vehicle as a leader aerial vehicle or a follower aerial vehicle, wherein the leader-follower communication may allow the leader aerial vehicle to provide leader reference position information to at least one other aerial vehicle or follower aerial vehicle.

The method may further comprise, by the data acquisition board, allowing the aerial vehicle to exchange global positioning system (GPS) time for synchronization or the leader-follower communication with another aerial vehicle with a data acquisition board of the other aerial vehicle.

The data acquisition board may comprise a single board computer module.

The method may further comprise, by the high-level control module, performing a real-time kinematics (RTK) GPS setup for the aerial vehicle.

According to the disclosure, there are provided a structure and operation method for a new multi-rotor system for the bistatic or multi-static SAR operation.

Further, according to the disclosure, there are provided a SAR drone system, which is manufactured easily using open-source hardware and operated safely and efficiently, and a method of operating the same.

Further, according to the disclosure, there are provided methods of manufacturing hardware of a subminiature multi-rotor system for operating a bistatic or multi-static SAR system, and performing control and data operation related to the multi-rotor system. The bistatic or multi-static SAR operation method may also be utilized in the field of swarm flight control for the multi-rotor system.

Further, according to the disclosure, at least two aerial vehicles are each provided with a transmitting module, a receiving module or a transceiving module, and a bi-static or multi-static SAR drone operation scenario, in which role changes or individual flights are optionally performed in the event of emergency situations, is applied thereto while a leader aerial vehicle is followed by a follower aerial vehicle, thereby providing an efficient and safe operation method for the SAR drone system.

Further, according to the disclosure, there are provided technologies related to new drone hardware and software for bistatic or multi-static SAR operation, which can perform search, exploration, and reconnaissance functions for military purposes regardless of weather conditions, and be utilized in land and ocean surveying for the purposes of government, private, etc.

Further, according to the disclosure, there is provided an SAR operation drone system, which can be actively used for positioning and surveying in various industrial fields such as autonomous driving, Internet of things (IoT), security, and logistics by taking advantages of radar imaging of a new drone-based SAR system.

### BRIEF DESCRIPTION OF DRAWINGS

FIG. 1 is a perspective view schematically showing the outer appearance of a multi-rotor structure drone, which is employable in a drone system for synthetic aperture radar (SAR) operation, according to an embodiment of the disclosure.

FIG. 2 is a block diagram showing a system configuration of a drone employable in an SAR operation drone system according to an embodiment of the disclosure.

FIG. 3 shows an illustration that the SAR operation drone system of FIG. 2 is implemented by the open-source hardware.

FIG. 4 is a schematic diagram illustrating a bistatic control technique for operating the SAR operation drone system of FIG. 3.

FIG. 5 is a schematic diagram illustrating a setup process employable in a bistatic SAR operation drone system according to another embodiment of the disclosure.

FIG. 6 shows an illustration for describing the principle of operating the bistatic SAR operation drone system according to an embodiment.

FIG. 7 shows an illustration for describing a setup process employable in a multi-static SAR operation drone system according to still another embodiment of the disclosure.

FIG. 8 is a schematic control block diagram for describing a frame synchronization principle employable in the multi-static SAR operation drone system of FIG. 7.

FIG. 9 shows an illustration for describing the principle of operating the multi-static SAR operation drone system of FIG. 7.

FIG. 10 is a schematic illustration for describing the principle of operating the SAR employable in the SAR operation drone system according to an embodiment of the disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

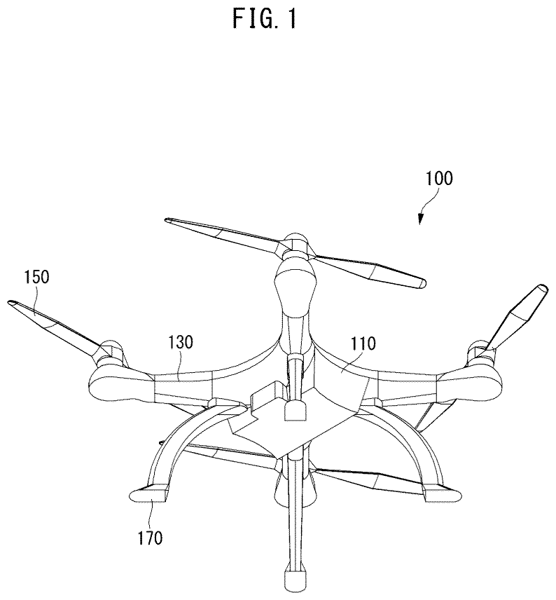

FIG. 1 is a perspective view schematically showing the outer appearance of a multi-rotor structure drone, which is employable in a drone system for synthetic aperture radar (SAR) operation, according to an embodiment of the disclosure.

Referring to FIG. 1, an SAR operation drone system 100 includes an aerial vehicle in the form of a multi-rotor or multi-copter, and a synthetic aperture radar (SAR) mounted to the aerial vehicle. Here, the aerial vehicle may be used to mean that it includes a control device, a storage device, a transceiving device, a sensor, a satellite antenna, an electric speed controller, a motor, a propeller 150, etc. in addition to the SAR.

The SAR refers to a radar system that sequentially transmits radar waves to the ground and ocean from the air and then processes a minute time difference between the radar waves reflected and returning from the curved surfaces of the ground or sea surface, thereby drawing a topographic map or observing a ground surface. Because of using the radar waves, the SAR is advantageous to be used day and night, and even in bad weather.

The aerial vehicle may include an aerial vehicle body 110 internally provided with a control device, a storage device, a transceiving device, a sensor, etc.; a connection frame 130 connecting the aerial vehicle body 110 and a tilting motor body; a motor and a propeller 150 included in the tilting motor body; and a plurality of legs 170 extending downward from the aerial vehicle body 110.

The SAR operation drone system 100 according to this embodiment may be used in the disclosure to provide a method of effectively manufacturing and operating a plurality of drones while acquiring SAR images through a formation flight of the plurality of drones, each of which is provided in the form of a multi-rotor or multi-copter. The SAR operation drone system 100 used in the disclosure may employ the multi-rotor with 2, 3, or 5 or more wings as well as 4 wings.

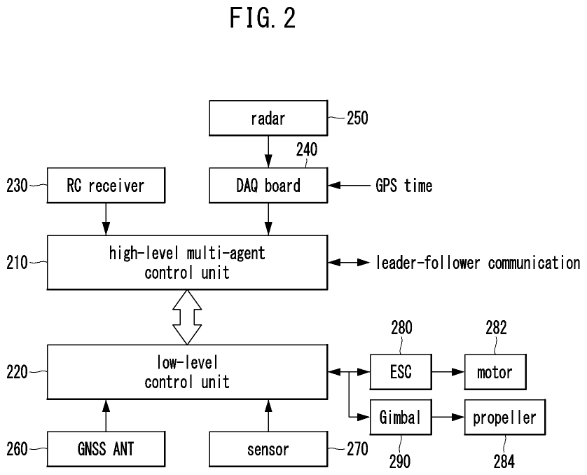

FIG. 2 is a block diagram showing a system configuration of a drone employable in an SAR operation drone system according to an embodiment of the disclosure.

Referring to FIG. 2, an SAR operation drone system 200 refers to a system in which the SAR is mounted to the aerial vehicle provided in the form of a multi-rotor or multi-copter, and is configured to operate by a bistatic SAR operation method or a multi-static SAR operation method.

To this end, the SAR operation drone system 200 includes a high-level multi-agent control unit 210, and a low-level control unit 220. Further, the SAR operation drone system 200 may include a remote control (RC) receiver 230, a data acquisition (DAQ) board 240, a radar 250, a global navigation satellite system (GNSS) antenna (GNSS ANT) 260, a sensor 270, an electric speed controller (ESC) 280, a motor 282, a propeller 284, and a gimbal 290.

The high-level multi-agent control unit 210 takes charge of control and communication for the flight and operation of the drones. The high-level multi-agent control unit 210 is responsible for the communication to perform swarm flight control among the plurality of drones. The high-level multi-agent control unit 210 may transmit a command to the low-level control unit 220 through wiring, a link, or a link module, and receive flight information from the low-level control unit 220.

Further, the high-level multi-agent control unit 210 may transmit a flight log to the DAQ board 240 so that a storage device in the DAQ board 240 can store the flight log. The high-level multi-agent control unit 210 may receive the command based on remote control from the RC receiver 230. In this case, the SAR operation drone system may be a leader drone or a drone individually controlled in emergency situations. Below, the high-level multi-agent control unit 210 may include a microprocessor or a controller, and may be briefly referred to as a high-level control (HLC) module.

The low-level control unit 220 may receive the command from the HLC module 210 through the wiring, the link, or the link module, and transmit the flight information to the HLC module 210. The low-level control unit 220 may receive global positioning information of a global navigation satellite system (or a global positioning system (GPS)) from the GNSS antenna 260. Further, the low-level control unit 220 may receive relative altitude information from the range sensor 270. In addition, the low-level control unit 220 may control the operations of the ESC 280 and the gimbal 290. Below, the low-level control unit 220 may be referred to as a flight control (FC) module.

The RC receiver 230 may receive a remote signal or a remote-control signal from a controller for remote control of the drone. According to an embodiment, when the plurality of drones in the SAR operation drone system 200 are used for the bistatic or multi-static SAR operation, the RC receiver 230 mounted to the leader drone among the plurality of drones may be configured to receive the remote-control signal from its own controller, but the RC receiver mounted to each of the follower drone(s) among the plurality of drones may be configured not to transmit the remote-control signal or the corresponding command to the high-level multi-agent control unit 210 even though it receives the remote-control signal from its own controller.

The DAQ board 240 may be provided with hardware for operations of analog input or output, digital input or output, a counter, and a timer. Further, the DAQ board 240 may store a flight log, a triggering log, etc. transmitted from the high-level multi-agent control unit 210, store GPS time for synchronization, and store radar data transmitted from the radar 250. In addition, the DAQ board 240 may be configured to exchange the GPS time with the DAQ board of another aerial vehicle in the formation flight for the synchronization or leader-follower communication with the other aerial vehicle.

The radar 250 includes the SAR mounted to the aerial vehicle. The radar 250 may include a radar module, and may be referred to as the radar module. Further, the SAR may be referred to as an SAR module, an SAR device, an SAR system, etc.

The GNSS antenna 260 receives radio waves transmitted from satellites that belong to a global measurement information service system. The radio waves are used to generate positioning information about a device provided with the GNSS antenna 260. The GNSS antenna 260 may be replaced with one of various satellite antennas that receive satellite signals.

The sensor 270 may include hardware that measures physical signals such as temperature, pressure, and vibration and converts the measured physical signals into electrical signals, i.e., voltage and current. Further, the sensor 270 may include an altitude sensor, a distance sensor, etc. for altitude measurement, distance measurement, etc., which are mounted to the aerial vehicle. Further, the sensor 270 may include an imaging sensor such as a camera. Further, the sensor 270 may be configured to transmit position information about a relative position of the aerial vehicle to the FC module.

The ESC 280 is mounted to the aerial vehicle and used to control the rotation speed of the motor 282 of the drone based on three-phase electricity. The ESC 280 may be placed between the flight control module and the motor 282, and may be mounted to a place with less effect on communication and electronic equipment. Further, the ESC 280 serves to regulate the voltage, and may be configured to supply high-voltage power from a battery to the FC module and the like devices that require low-voltage power.

The motor 282 refers to a device that is mounted to the aerial vehicle and converts electrical energy based on the power of the ESC 280 into rotational motion. The motor 282 may serve to rotate or stop the propeller 284 for the takeoff, movement, flight, and landing operations of the drone. The motor 282 may employ a brushless direct current (BLDC) motor, a servo motor, etc.

The propeller 284 refers to a rotary wing-mounted device that is mounted to the aerial vehicle and converts the rotational force of the motor 282 into propulsion. The propeller 284 may include a first propeller that rotates clockwise and a second propeller that rotates counterclockwise.

The gimbal 290 is mounted to the aerial vehicle and fixes the imaging sensor, such as a camera, to a drone body. The gimbal 290 refers to a device that prevents the imaging sensor from shaking even when the drone shakes. The gimbal 290 controls the imaging sensor to move at the same speed and angle as but in the opposite direction to the drone body connected to one end of the gimbal 290, thereby preventing the imaging sensor from shaking.

For example, when a body of a multi-rotor performs clockwise roll-rotation by a first angle in the state that the gimbal 290 is connected to the multi-rotor, the gimbal 290 may make the imaging sensor perform counterclockwise roll-rotation at the same speed. In this case, the imaging sensor does not move even though the multi-rotor moves, thereby having the same effect as if the imaging sensor is stationary. The gimbal 290 may include a one-axial gimbal, a two-axial gimbal, a three-axial gimbal, etc.

In the SAR operation drone system according to the foregoing embodiment, the plurality of drones, each of which includes the high-level multi-agent control unit and the low-level control unit, share position target information and estimated position therebetween, so that the leader drone among the plurality of drones can share estimated position information or leader reference position information with the follower drone, thereby effectively performing a formation flight or a swarm flight. Further, in the event of emergency situations, such as poor communication and a malfunction of the aerial vehicle, the leader and the followers may be changed through mode switching or the control authority of each aerial vehicle may be returned to an individual controller to improve stability and reliability in operating the drone system.

The SAR operation drone system to be described below may basically include at least two drone devices or drone systems for the bistatic or multi-static operation. However, for convenience of description, the SAR operation drone system may also be used to refer to a single drone.

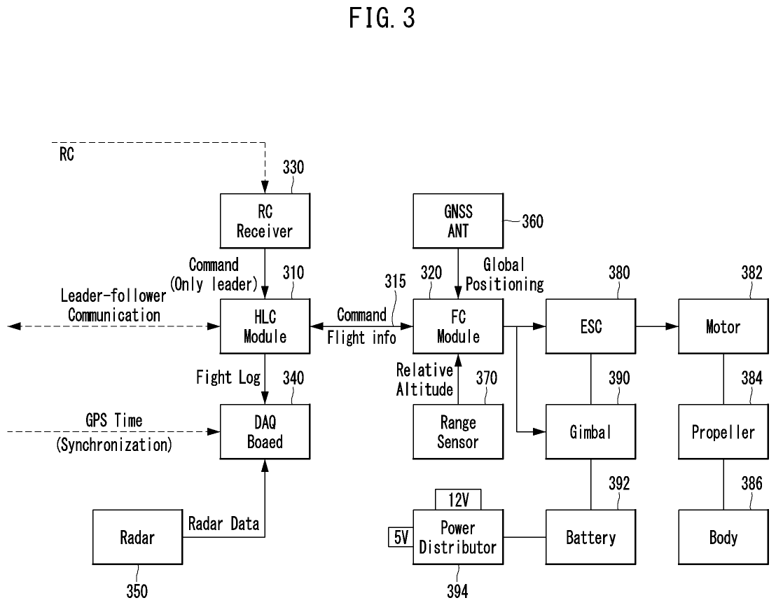

FIG. 3 shows an illustration that the SAR operation drone system of FIG. 2 is implemented by the open-source hardware.

Referring to FIG. 3, the SAR operation drone system (hereinafter referred to as a ‘drone system’) 300 may include three computing modules as main hardware components. The three computing modules may include a high-level computer (HLC) module 310, an FC module 320, and a single board computer (SBC) module 340 for data storage. The HLC module 310 and the FC module 320 may be linked by a link module 315. The link module 315 may have a wiring or cable structure to physically connect the HLC module 310 and the FC module 320.

Further, the drone system 300 may include a RC receiver 330, a DAQ board 340, a radar 350, a GNSS ANT 360, and a range sensor 370.

Further, the drone system 300 may further include an electric speed control (ESC) 380, a motor 382, a propeller 384, a body 386, a gimbal 390, a battery 392, and a power distributer 394.

Each component of the foregoing drone system will be described in more detail as follows.

The HLC module 310 is in charge of communication to perform swarm control of the drones. In other words, the HLC module 310 mounted to a first drone may perform leader-follower communication with at least one other drone. The HLC module 310 transmits a command to the FC module 320 through the link module 315, and receives the flight information from the FC module 320.

Further, the HLC module 310 may store a flight log in the storage device of the DAQ board 340. In addition, the HLC module 310 may receive the command based on the remote control from the RC receiver 330. In this case, the SAR operation drone system may be the leader drone or the drone to be individually controlled in case of emergency situations.

The HLC module 310 may be configured, for example, using a micro control unit of the ARM's Cortex-M7 series. In the case of chips of the ARM's Cortex M7 series, the chips may be easily purchased online, and a board with the built-in corresponding micro control chip may also be easily purchased.

The FC module 320 performs low level control for the drone. The low level includes the ESC 380, the motor 382, the propeller 384, the body 386, the gimbal 390, the battery 392, the power distributer 394, etc.

The FC module 320 may receive a command from the HLC module 310 through the link module 315 and transmit flight information to the HLC module 310. The FC module 320 may receive global positioning information from a global navigation satellite system (or a global positioning system) from the GNSS antenna 360. Further, the FC module 320 may receive relative altitude information from the range sensor 370. In addition, the FC module 320 may control the operations of the electric speed controller 380 and the gimbal 390.

The FC module 320 may use a flight controller such as Pixhawk4, which is an open-source platform. In this case, the operating system may employ Pixhawk project, Pixhawk, or PX4. The PX4 was developed as a sub-project of the ArduPilot, i.e., an open-source automatic control system aimed at an unmanned and autonomous aircraft, as a remote-control drone and an automatic control device. The PX4 refers to a platform that operates on a flight control board with software based on the NuttX operating system designed for the remote control and autonomous flight of the unmanned aircraft such as a quadcopter. The PX4 may also be operated with ground control systems such as ‘QGroundController’ and remote-control applications such as ‘drone kit.’

The link module 315 may be configured to operate based on the independent Ethernet.

Furthermore, the link module 315 may have a plug-and-play function that allows the HLC module 310 and the FC module 320 to be used immediately after connection. The link module 315 may have digital and analog input and output functions for input output link (IO-link) communication in one module.

The SBC module 340 may include the DAQ board. The SBC module 340 may receive, store, and utilize the flight log from the HLC module 310. The SBC module 340 may receive, store, and utilize GPS time for synchronization. Further, the SBC module 340 may receive, store and utilize radar data from the radar 350.

The SBC module 340 refers to an independent computer with a single circuit board that has functions such as a microprocessor, a memory, and input/output devices, and may be characterized by ultra-small size and low power and perform the leader-follower communication.

The SBC module 340 may be connected to a backplane for system expansion. The SBC module 340 may be configured using the Raspberry Pi, ODROID, BeagleBoard, Lattepanda alpha, etc.

The RC receiver 330 may receive a remote control (RC) signal from the remote controller. Further, the RC receiver 330 may transmit the command based on the remote-control signal to the HLC module 310. The RC receiver 330 may be configured using the HiTEC Optima series, etc.

At least one of hardware components of the aerial vehicle, such as the radar 350, the GNSS antenna 360, the range sensor 370, the ESC 380, the motor 382, the propeller 384, the body 386, the gimbal 390, the battery 392, and the power distributer 394, which are directly or indirectly connected to at least one of the foregoing three main components, may be configured using off-the-shelf products.

For example, the radar 350 may use a product of Modular anti-drone systems (MADS). The GNSS antenna 360 may use Holybro's GNSS product series, e.g., the helical GPS module. The range sensor 370 may use Lightware's SF11/C. The ESC 380 may use a product from Hobbywing, e.g., XRotor 40A, etc. The motor 382 may use a product of T-Motor, e.g., 2216-880 kV, etc. The propeller 384 may use a product of T-Motor, e.g., Airgear T1045, etc. The body 386 may use a product of Tarot, e.g., S550, etc. The gimbal 390 may use a product of Tarot, e.g., T3D-V. The battery 392 may use a product of PolyTronics (PT), e.g., B6500N series. In addition, the power distributer 394 may include a DC-DC converter that supplies 5V and 12V to the battery 392, and may use the existing product having such functions.

In terms of the operations of the drone system, the HLC module 310 plays the most important role. The HLC module 310 may receive the positioning information of the aerial vehicle, such as the position and speed of the aerial vehicle through the dedicated link 315 such as the Mavlink from the FC module 320 and calculate appropriate control inputs by sharing the positioning information with other aerial vehicles in the swarm flight through the wireless communication. The calculated control information may be transmitted to the FC module 320, and the FC module 320 may perform single drone control based on the received control information. Additionally, the HLC module 310 transmits data required for storage to the SBC so that the SBC can store the data.

Meanwhile, according to an alternative example of this embodiment, the components of the SBC module 340 including the foregoing DAQ board and the radar 350 may be replaced with an embedded personal computer (ePC) module, radar DAQ, and a radar module. In this case, the ePC module may be configured to receive information about a flight log and a triggering log from the HLC module, transmit signals to the radar module connected through an application programming interface (API), and receive the radar data from the radar module through the radar DAQ. Further, the radar module may be configured to receive hardware triggering signals from the HLC module. This alternative structure may correspond to that the SBC module 340 includes the ePC module and the radar DAQ board.

According to the present embodiment, the HLC module 310, the link module 315, the FC module 320, and the SBC module 340 can be easily mounted on a hardware base of the drone system, thereby enabling the drone system to be simply and quickly manufactured, and since at least one of the HLC module 310, the link module 315, the FC module 320, and the SBC module 340 can be replaced with at least one of compatible modules, there is an advantage in that repairs and maintenance can be performed very efficiently.

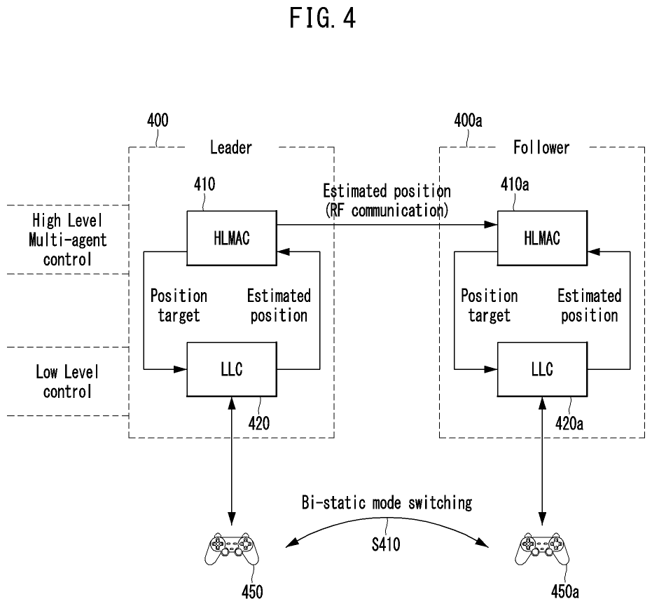

FIG. 4 is a schematic diagram illustrating a bistatic control technique for operating the SAR operation drone system of FIG. 3.

Referring to FIG. 4, the bistatic SAR operation drone system may include a first drone system 400, which may operate as the leader, and a second drone system 400a, which may operate as the follower.

The first drone system 400 may include a first HLC module 410 for high-level multi-agent control (HLMAC), and a first FC module 420 for low-level control (LLC).

The first HLC module 410 may transmit position target information to the first FC module 420. In this case, the first FC module 420 may control a moving direction or distance of the drone system by controlling the operations of the low-level devices of the drone system based on the position target information. Further, the first FC module 420 may transmit estimated position information to the first HLC module 410.

Similarly, the second drone system 400a may include a second HLC module 410a for the HLMAC, and a second FC module 420a for the LLC.

The second HLC module 410a may transmit the position target information to the second FC module 420a. In this case, the second FC module 420a may control a moving direction or distance of the drone system by controlling the operations of the low-level devices of the drone system based on the position target information. Further, the second FC module 420a may transmit estimated position information to the second HLC module 410a.

The first HLC module 410 of the first drone system 400 operating as the foregoing leader may transmit the estimated position information to the second HLC module 410a of the second drone system 400a operating as the follower. The first HLC module 410 may transmit the estimated position information to the second HLC module 410a through radio frequency communication (RF comm.).

The RF communication may have a frequency band of 30 kHz to 300 GHz. The RF communication may include short-range wireless communication for transmitting information wirelessly within a relatively close range of approximately tens of meters. The short-range wireless communication may include WiFi, Bluetooth, near field communication (NFC), radio frequency identification (RFID), Zigbee, Z-wave, etc., which have already well known. The RF communication may employ various techniques such as amplitude shift keying (ASK) and pulse width modulation (PWM) to transmit digital signals.

The first drone system 400 may be configured to be remotely controlled by a first remote controller 450, and the second drone system 400a may be configured to be remotely controlled by a second remote controller 450a. However, while operating in a bi-static mode, the second drone system 400a may perform the swarm flight or the formation flight by following the first drone system 400, based on the estimated position information transmitted from the first drone system 400 regardless of the remote control from the second remote controller 450a. Below, the remote controller may be simply referred to as a controller.

According to an embodiment, in case of switching the bi-static mode (S410), that is, when the roles of the leader drone and the follower drone are reversed in the bistatic SAR operation drone system, the first drone system 400 may operate as the follower drone and the second drone system 400a may operate as the leader drone.

As described above, each aerial vehicle in the bistatic SAR operation drone system may be basically operated by a remote controller individually connected thereto. During the swarm flight, only the leader aerial vehicle is operated by the controller, and the follower aerial vehicle is operated following the leader aerial vehicle and maintaining the swarm formation. Therefore, during the swarm flight, the remote controller connected to the follower aerial vehicle may be basically limited in control authority for the corresponding aerial vehicle. However, when an emergency situation such as the aerial vehicle malfunction and/or poor communication occurs and thus an emergency landing is required for that reason, the controller of the follower aerial vehicle may take back the control authority, thereby improving safety compared to a method of operating the bistatic SAR operation drone system with only one remote controller.

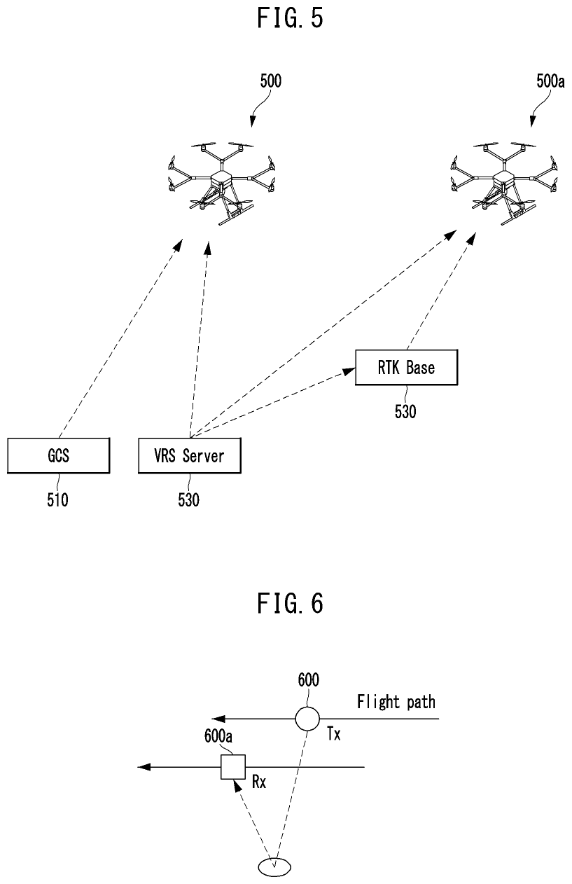

FIG. 5 is a schematic diagram illustrating a setup process employable in a bistatic SAR operation drone system according to another embodiment of the disclosure.

Referring to FIG. 5, the bistatic SAR operation drone system may be set up by a real-time kinematics (RTK) GPS setup. To set up the RTK GPS for two drones 500 and 500a, which are referred to as rovers, there may be used a drone GPS setup system including a base 510, a virtual reference system (VRS) server 530, and ground control stations (GCS) 550. The base 510 may be referred to as a GPS base or an RTK base.

The VRS server 530 may be placed adjacent to the base 510 and the two drones 500 and 500a, and transmit GPS data to the base 510 and each of the drones 500 and 500a so that the base 510 and each of the two drones can calculate their own GPS errors. The two drones may be referred to as a first drone 500 and a second drone 500a, respectively.

The VRS server 530 may continuously receive position information for each of the drones from the two drones 500 and 500a as dataset in a preset interface format, e.g., a GPS fix data (GGA) format of national marine electronics association (NMEA). The GGA dataset includes information about time, longitude, latitude, system quality, the number of satellites in use, and height. The interface format may be replaced with any format selected from among geographic position-latitude/longitude (GLL), GNSS DOP & active satellites (GSA), GNSS satellites in view (GSV), recommended minimum specific GNSS data (RMC), course over ground (VTG), time and data (ZDA), etc. instead of the GGA.

Using the above-described RTS GPS setup, the bistatic SAR operation drone system may be configured to allow the drone 500 and/or 500a to receive a GPS data error from the GPS base 510 and correct its own GPS position.

FIG. 6 shows an illustration for describing the principle of operating the bistatic SAR operation drone system according to an embodiment.

Referring to FIG. 6, the bistatic SAR operation drone system includes a first drone 600, which is the leader, and the second drone 600a, which is the follower that follows the leader. The first drone 600 includes a transmitting module that transmits an RF signal, and the second drone 600a includes a receiving module that receives an RF signal. In particular, according to an embodiment, the first drone 600 may further include a receiving module for receiving an RF signal, and the second drone 600a may further include a transmitting module for transmitting an RF signal. The transmitting module and the receiving module may be formed as a single structure of a transceiving module.

Here, the transmitting module may be used as a meaning of including an SAR transmitter, a receiving module may be used as a meaning of including an SAR receiver, and the transceiving module may be used as a meaning of including an SAR transceiver.

The foregoing first drone 600 and the second drone 600a may correspond to the first drone system 400 and the second drone system 400a shown in FIG. 4. Further, the first drone 600 and the second drone 600a may correspond to the first drone 500 and the second drone 500a shown in FIG. 5. The first drone 600 and the second drone 600a may have an aerial vehicle structure in the form of a multi-rotor or multi-copter.

In the bistatic SAR operation drone system according to this embodiment, the first drone 600 may fly along any flight path that is preset or remotely controlled in real-time. The first drone 600, i.e., the leader drone may perform an RF signal transmission (Tx) operation through the SAR during the flight.

The second drone 600a refers to the follower drone that follows the first drone 600 and performs the swarm flight or the formation flight together with the first drone 600, and may perform an RF signal reception (Rx) operation through the SAR during the flight. The RF signal may include a reflected wave (i.e., an RF signal) as the RF signal transmitted from the SAR of the first drone 600 is reflected and returning from the ground or sea surface.

The first drone 600 and the second drone 600a may have corrected their GPS position information through the RTK GPS setup process before starting the swarm flight.

Further, in undesired emergency situations such as poor communication between the first drone 600 and the remote controller of the first drone 600, communication disconnection, and aerial vehicle malfunction, each of the first drone 600 and the second drone 600a may be configured to perform automatic mode switching based on the bistatic mode switching function set to operate automatically under emergency conditions so that the first drone 600 can switch over from the leader drone to the follower drone and the second drone 600a can switch over from the follower drone to the leader drone.

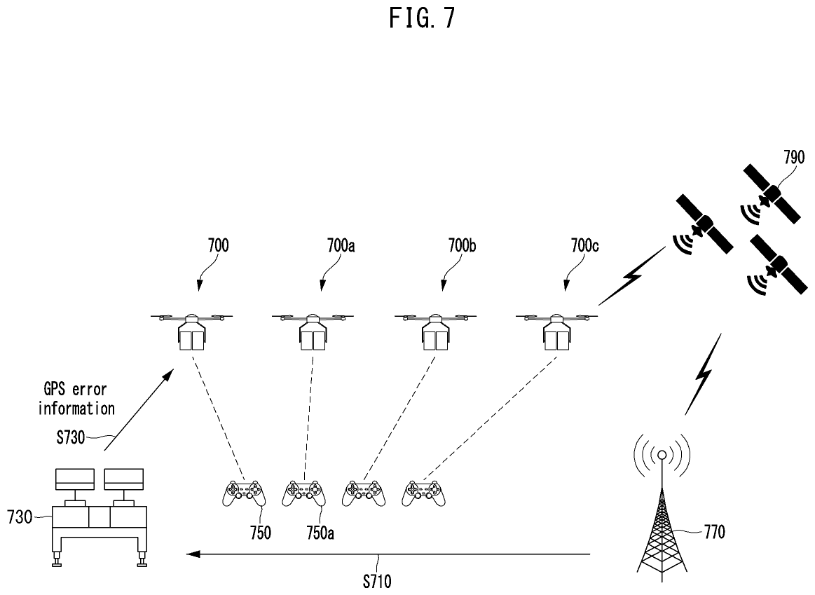

FIG. 7 shows an illustration for describing a setup process employable in a multi-static SAR operation drone system according to still another embodiment of the disclosure.

Referring to FIG. 7, the multi-static SAR operation drone system may be set up by the real-time kinematics (RTK) GPS setup. To set up the RTK GPS for a plurality of drones 700, 700a, 700b, and 700c, which are referred to as rovers, there may be used a drone GPS setup system including a base station 770 receiving GPS data from a satellite system 790 and functioning as a GPS base, and a ground control system 730 having a function of a virtual reference system (VRS).

The plurality of drones 700, 700a, 700b, and 700c may be remotely controlled by individual controller 750 and 750a. For example, four drones may be referred to as a first drone 700, a second drone 700a, a third drone 700b, and a fourth drone 700c, respectively. Further, the four controllers may be referred to as a first controller 750, a second controller 750a, a third controller, and a fourth controller, respectively.

In more detail, the base station 770 may be installed at a position known in advance with GPS coordinates, etc. The base station 770 may be provided in the form of a mobile device or a stationary device. In addition, the base station 770 refers to a device of which GPS position information is known, and may be replaced by a radio network system (RNS), evolved NodeB (eNB), next generation NodeB (gNB), etc., corresponding to the base station of a RAN or access network. The access network may include a centralized random access network or cloud RAN (C-RAN), and may include a mobile communication base station, a repeater, an RF unit (RU), etc. as the stationary devices to directly or indirectly communicate with the satellite system 790 and the ground control system 730, means for performing similar functions, or components function as such means.

The ground control system 730 may receive GPS data from the base station 770 (S710), perform inverse GPS error computation considering errors in consideration of an error caused by the ionosphere or the like, and transmit the calculated GPS error information to each of the drones 700, 700a, 700b, and 700c (S730).

In other words, the ground control system 730 may transmit GPS error information to each of the drones 700, 700a, 700b, and 700c, so that each drone can calculate its own GPS position accurately.

Based on the foregoing RTS GPS setup, the multi-static SAR operation drone system may be configured to allow each of the drone 700, 700a, 700b and 700c to receive the GPS error information from the ground control system 730 and calculate an accurate position by correcting its own GPS position.

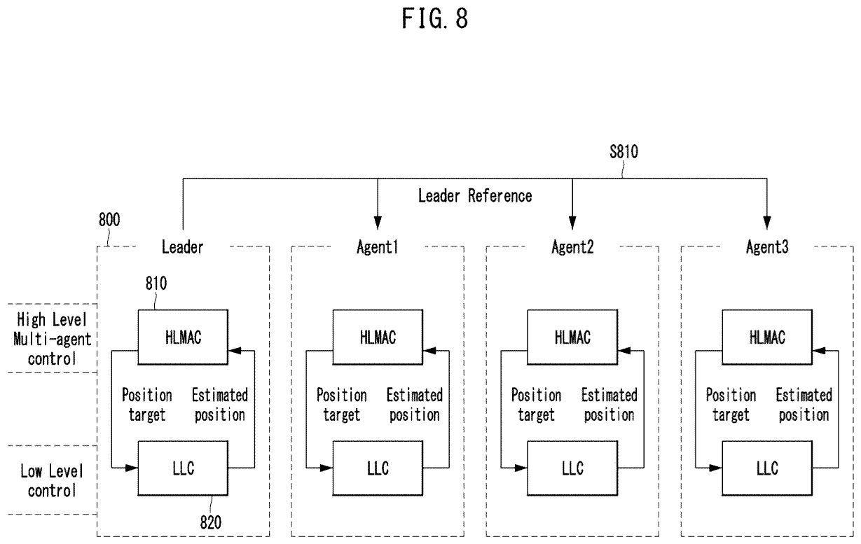

FIG. 8 is a schematic control block diagram for describing a frame synchronization principle employable in the multi-static SAR operation drone system of FIG. 7.

Referring to FIG. 8, the multi-static SAR operation drone system may include a first drone system 800, which may be referred to as the leader, and a plurality of second drone systems, which may operate as the followers. In this embodiment, the second drone systems are illustrated as including three drone systems. The three second drone systems may be referred to as a first agent Agent 1, a second agent Agent 2, and a third agent Agent 3, respectively.

The first drone system 800 may include a first HLC module 810 having a means for a high-level multi-agent control (HLMAC) function or a component performing the function corresponding to such means, and a first FC module 820 having a means for a low-level control (LLC) function or a component performing the function corresponding to such means.

The first HLC module 810 may transmit position target information to the first FC module 820. In this case, the first FC module 820 may control the operations of the low-level devices of the first drone system 800 based on the position target information, thereby controlling a moving direction or distance of the first drone system 800. Further, the first FC module 820 may transmit estimated position information to the first HLC module 810.

Similarly to the first drone system, each of the second drone systems may include a second HLC module for the HLMAC and a second FC module for the LLC. In each second drone system, the second HLC module may transmit the position target information to the second FC module. In this case, the second FC module may control a moving direction or distance of the second drone system by controlling the operations of the low-level devices of the second drone system based on the position target information. Further, the second FC module may transmit the estimated position information to the second HLC module.

The foregoing first drone system 800 may transmit the leader reference position information or the estimated position information based on the leader's position to each of the second drone systems, which follow the first drone system 800, through RF communication (S810).

A reference frame for identifying the leader reference position may be set according to the use position of the SAR operation drone system. In other words, the reference frame may be set according to a coordinate system determined based on the leader's position on the Earth. The coordinate system may include an earth-centered earth-fixed (ECEF) coordinate system, an east, north, up (ENU) coordinate system, and a latitude, longitude, altitude (LLA) coordinate system.

For example, the leader may transmit the reference position in the form of the latitude, longitude, and altitude (LLA) based on the latitude, longitude and altitude to the followers, i.e., the first to third agents.

Each follower may calculate the reference position in the north east down (NED) frame using a predefined reference frame for an SAR operation place based on the received reference position of the leader. The NED frame refers to a ground coordinate system that corresponds to the LLA coordinate system or may also be referred to as an LLA coordinate system or an LLA frame. Further, each follower may convert the reference position into an LLA frame for the LLC.

The foregoing first drone system 800 may be configured to be remotely controlled by the first controller, and each of the second drone systems may be configured to be remotely controlled by each of the plurality of second controllers. However, while operating in the multi-static mode, all the second drone systems may perform the swarm flight or the formation flight by following the first drone system 800, based on the leader reference position information received from the first drone system 800 regardless of the remote control from the second remote controller.

In the foregoing multi-static SAR operation drone system, every aerial vehicle may be basically operated through the controller individually connected to each aerial vehicle, and, during the swarm flight, only the leader aerial vehicle may be operated by the controller and the follower aerial vehicles may be operated to maintain the swarm formation by following the leader aerial vehicle.

Meanwhile, similarly to the case of switching the foregoing bi-static mode, the multi-static SAR operation drone system according to this embodiment may be configured to switch the operation mode of any second drone system among the plurality of second drone systems operating in the follower mode over to the leader mode and switch the leader mode of the first drone system 800 over to the follower mode or a leader stop mode.

In other words, during the swarm flight, the controller connected to the follower aerial vehicle may be basically limited in control authority for the corresponding aerial vehicle. However, when an emergency situation such as the aerial vehicle malfunction and/or poor communication occurs and thus an emergency landing is required for that reason, the controller of the follower aerial vehicle may take back the control authority, thereby improving reliability and safety in operating the multi-static SAR operation drone system.

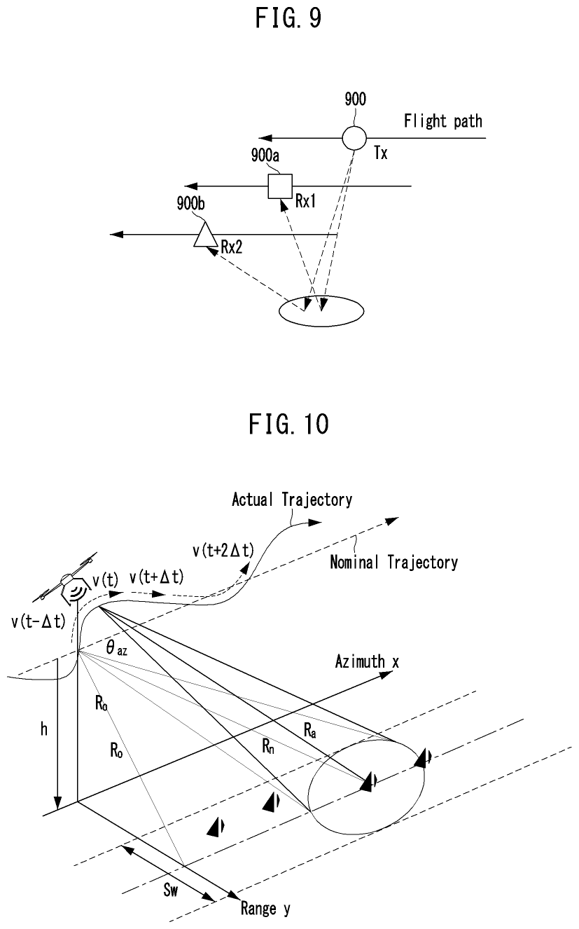

FIG. 9 shows an illustration for describing the principle of operating the multi-static SAR operation drone system of FIG. 7.

Referring to FIG. 9, the multi-static SAR operation drone system may include a first drone 900 as the leader, and a second drone 900a and a third drone 900b as the followers following the first drone 900. The first drone 900 may include a transmitting module that transmits an RF signal, and the second drone 900a and the third drone 900b may include receiving modules that receive the RF signals. In particular, according to an embodiment, the first drone 900 may further include a receiving module that receives the RF signal, and at least one of the second drone 900a and the third drone 900b may further include a transmitting module that receives the RF signal. The transmitting module and the receiving module may be mounted to each drone as a single structure of the transceiving module.

The foregoing first drone 900 may correspond to the first drone system 700 shown in FIG. 7, and the second drone 900a and the third drone 900b may correspond to the two second drone systems 700a and 700b) shown in FIG. 7. Further, the first drone 900 may correspond to the first drone system 800 shown in FIG. 8, and the second drone 900a and the third drone 900b may correspond to the two second drone systems shown in FIG. 8, i.e., the first agent Agent 1 and the second agent Agent 2. Each of the drones 900, 900a, and 900b may have an aerial vehicle structure in the form of a multi-rotor or a multi-copter.

In the multi-static SAR operation drone system according to this embodiment, the first drone 900 may fly along any flight path that is preset or remotely controlled in real-time. The first drone 900, i.e., the leader drone may perform an RF signal transmission (Tx) operation through the SAR during the flight.

The second drone 900a, i.e., the follower following the leader may follow the first drone 900 at a first distance, and perform the swarm flight or the formation flight together with the first drone 900 and the third drone 900b. Likewise, the third drone 900b, i.e., another follower may follow the first drone 900 at the first distance or a second distance different from the first distance, and perform the swarm flight or the formation flight together with the first drone 900 and the second drone 900a.

The second drone 900a may perform a reception (Rx1) operation for an RF signal through the SAR during the flight following the first drone 900. Further, the third drone 900b may perform a reception (Rx2) operation for an RF signal through the SAR during the flight following the first drone 900. Here, the RF signal may include a reflected wave (i.e., an RF signal) as the RF signal transmitted from the SAR of the first drone 900 is reflected and returning from the ground or sea surface.

The first drone 900, the second drone 900a and the third drone 900b may have calculated their own GPS position information accurately or to match each other through the RTK GPS setup process before starting the swarm flight.

Further, in undesired emergency situations such as poor communication between the first drone 900 and the remote controller of the first drone 900, communication disconnection, and aerial vehicle malfunction, any one of the second drone 900a and the third drone 900b may be configured to perform automatic operation mode switching based on a mode switching function set to operate automatically under emergency conditions so as to switch over from the follower to the leader. In this case, the first drone 900 may be configured to automatically switch its own operation mode from the leader mode over to the follower mode or the leader stop mode, based on a preset automatic mode switching function or trigger conditions.

FIG. 10 is a schematic illustration for describing the principle of operating the SAR employable in the SAR operation drone system according to an embodiment of the disclosure.

The SAR system refers to an imaging radar mounted to a high-speed moving platform such as a satellite and a high-altitude long endurance (HALE) unmanned aerial vehicle (UAV). In this embodiment, the SAR system is the imaging radar basically mounted to the multi-rotor or the multi-copter. The SAR operation drone system may operate in the bi-static or multi-static SAR operation mode to implement various imaging modes by adjusting an antenna radiation pattern of the SAR system mounted to the leader according to the operation modes. In the case of a phase array antenna applicable to the SAR system, the radiation pattern may be synthesized by dividing the antenna into small apertures and adjusting the phase and size of the transceiving modules. Here, a sufficient aperture ratio is required for each aperture for the purpose of the azimuth resolution.

Further, the SAR system may store the RF signal received from each radar of the followers in the DAQ board through an intermediate frequency block. In this case, the SAR system is implemented based on a small unmanned aerial vehicle such as the drone, which is relatively lightweight and operates at a relatively low operating altitude, and thus unwanted fluctuation may occur due to air, thereby causing a problem of degrading the quality of the SAR image due to the fluctuation. A distance error caused by the drone's fluctuation may cause the phase error in an SAR reception signal, thereby degrading the quality of the composite image.

For example, as shown in FIG. 10, it may be simulated that the SAR of the SAR operation drone moving along a predetermined path at a predetermined altitude/height h fluctuates with respect to a point target P on a coordinate system with an x-axis for azimuth Azimuth x and a y-axis for range Range y.

In FIG. 10, Ro is the shortest distance between an arbitrary point target P and the SAR sensor (see 250 in FIG. 2 or 350 in FIG. 3) based on an ideal path, i.e., a nominal trajectory, Ra is an actual distance between the drone and the target, and Rn is an ideal distance between the drone and the target. Further, v(t) is the speed of the drone at time (t), and Sw is an image target area in the distance axial direction centering on the point target (P).

The characteristics of the SAR reception signal for the point target (P) may be identified through a frequency modulation continuous wave (FMCW) SAR reception signal to which the drone's actual trajectory or actual path is applied. As a result, the characteristics of the SAR reception signal may be identified based on a frequency component depending on a center frequency of the SAR signal, a frequency modulation rate of the FMCW signal, and a distance between the target and the SAR sensor. In other words, when the drone's fluctuations are reflected, a phase error may occur due to a distance error or a path error. In particular, if very serious fluctuations occur in the drone, not only the phase error but also a range cell migration error may occur, thereby causing additional quality deterioration in the SAR image.

Accordingly, the SAR operation drone system according to this embodiment may include a means for correcting errors such as the phase error and the range cell migration error, or a component that performs functions corresponding to that means.

According to the foregoing embodiment, the SAR operation drone system includes the high-level multi-agent control unit and the low-level control unit, and effectively performs the formation flight or swarm flight as the leader shares the estimated position information or the leader reference position information while sharing the position target information and the estimated position therebetween, and improves stability and reliability in operating the drone system as the leader and the follower are reversed through mode switching or the control authority for each aerial vehicle is returned to the individual controller in the event of emergency situations such as poor communication or aerial vehicle malfunction.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A drone system for synthetic aperture radar (SAR) operation to control and operate an aerial vehicle mounted with an SAR, comprising:
a flight control module configured to control a low level of the aerial vehicle;
a high-level control module configured to perform communication for swarm control of the aerial vehicles, receive flight information from the flight control module, and transmit a command to the flight control module;
a link module configured to link the flight control module and the high-level control module; and
a data acquisition board connected to the high-level control module and configured to store a flight log from the high-level control module and radar data from a radar module provided with the SAR.

2. The drone system of claim 1, further comprising a satellite antenna connected to the flight control module and configured to receive a satellite signal from a satellite,
wherein the flight control module receives global positioning information calculated based on the satellite signal from the satellite antenna, and transmits the flight information based on the global positioning information to the high-level control module through the link module.

3. The drone system of claim 1, further comprising a sensor connected to the flight control module and configured to transmit position information about a relative position of the aerial vehicle to the flight control module.

4. The drone system of claim 1, further comprising a remote-control receiver connected to the high-level control module and configured to transmit a command received from an external controller to the high-level control module.

5. The drone system of claim 4, wherein the aerial vehicle is a follower aerial vehicle, and the high-level control module receives a command for controlling operations of the follower aerial vehicle from the remote-control receiver based on operation mode switching upon preset emergency situations such as malfunction of a leader aerial vehicle or poor communication of the leader aerial vehicle.

6. The drone system of claim 1, wherein the high-level control module provides position target information of the aerial vehicle to the flight control module, and the flight control module provides estimated position information about the aerial vehicle to the high-level control module.

7. The drone system of claim 6, wherein the high-level control module performs communication control between a leader aerial vehicle and a follower aerial vehicle or communication control between agents, and the leader aerial vehicle provides estimated position information or leader reference position information to the follower aerial vehicle.

8. The drone system of claim 1, wherein the data acquisition board exchanges global positioning system (GPS) time for synchronization or leader-follower communication with another aerial vehicle with a data acquisition board of the other aerial vehicle.

9. The drone system of claim 1, wherein the data acquisition board comprises a single board computer module.

10. The drone system of claim 1, further comprising an electric speed controller connected to the flight control module.

11. A method of operating a synthetic aperture radar (SAR) operation drone system for controlling and operating an aerial vehicle mounted with an SAR, the method comprising:
by a flight control module, controlling a low level of the aerial vehicle;
by a high-level control module linked to the flight control module through a link module, performing communication for swarm control of the aerial vehicles,
by the high-level control module, receiving flight information from the flight control module, and transmitting a command to the flight control module; and
by a data acquisition board connected to the high-level control module, storing a flight log from the high-level control module and radar data from a radar module provided with the SAR.

12. The method of claim 11, further comprising:
by a satellite antenna connected to the flight control module, receiving a satellite signal from a satellite; and
by the satellite antenna, transmitting global positioning information calculated based on the satellite signal to the flight control module,
wherein the flight control module transmits the flight information based on the global positioning information to the high-level control module through the link module.

13. The method of claim 11, further comprising, by a sensor connected to the flight control module, transmitting position information about a relative position of the aerial vehicle to the flight control module.

14. The method of claim 11, further comprising, by a remote-control receiver connected to the high-level control module, transmitting a command received from an external controller to the high-level control module,
wherein the command is received in the remote-control receiver from the external controller for remote control of the aerial vehicle, the SAR or the formation flight.

15. The method of claim 14, further comprising, by the high-level control module, receiving a command based on a remote-control signal of the controller from the remote-control receiver,
wherein the command is transmitted to the aerial vehicle serving as a leader aerial vehicle, or transmitted to a follower aerial vehicle that has performed a swarm flight together with the leader aerial vehicle and switched over to a leader aerial vehicle mode based on operation mode switching upon preset emergency situations such as malfunction of the leader aerial vehicle or poor communication of the leader aerial vehicle.

16. The method of claim 11, further comprising:
by the high-level control module, providing position target information of the aerial vehicle to the flight control module; and
by the flight control module, providing estimated position information about the aerial vehicle to the high-level control module.

17. The method of claim 11, further comprising, by the high-level control module, allowing the aerial vehicle to perform leader-follower communication with a counterpart aerial vehicle as a leader aerial vehicle or a follower aerial vehicle,
wherein the leader-follower communication allows the leader aerial vehicle to provide leader reference position information to at least one other aerial vehicle or follower aerial vehicle.

18. The method of claim 17, further comprising, by the data acquisition board, allowing the aerial vehicle to exchange global positioning system (GPS) time for synchronization or the leader-follower communication with another aerial vehicle with a data acquisition board of the other aerial vehicle.

19. The method of claim 11, wherein the data acquisition board comprises a single board computer module.

20. The method of claim 11, further comprising, by the high-level control module, performing a real-time kinematics (RTK) GPS setup for the aerial vehicle.
